(19) United States
(12) Patent Application Publication
(10) Pub. No.: US 2008/0208911 A1
(43) Pub. Date: Aug. 28, 2008

(54) METHOD AND APPARATUS FOR EVALUATING INTERNET CONTENTS, AND RECORDING MEDIA FOR STORING PROGRAM IMPLEMENTING THE SAME

(75) Inventors: Jun Ho LEE, Goyang Si (KR); Do Hyoung KIM, Seoul (KR)

Correspondence Address: EDWARDS ANGELL PALMER & DODGE LLP, P.O. BOX 55874, BOSTON, MA, 02205, US

(73) Assignee: NETDIVER CO., LTD., Seoul (KR)

(21) Appl. No.: 12/025,135

(22) Filed: Feb. 4, 2008

(30) Foreign Application Priority Data
Feb. 6, 2007 (KR) 10-2007-0012256

(51) Int. Cl. G06F 17/30

(52) U.S. Cl. 707/104.1; 707/E17.001

(57) ABSTRACT

Disclosed is a method for evaluating Internet contents created by users through an automatic analysis and output and recording media for storing a program implementing the same. The method includes inputting location information of Internet contents to be evaluated; automatically extracting predetermined evaluation factors from the Internet contents corresponding to the inputted location information; evaluating the Internet contents by substituting the extracted evaluation factors into a predetermined algorithm; and outputting evaluation information. Furthermore, a database for the corresponding contents, which is obtained based on the extracted evaluation factors and the information inputted by the user, enables a systematic provision for evaluation and ranking of the contents.

### CROSS-REFERENCE TO RELATED APPLICATION

This application claims the benefit of Korean Patent Application No. 10-2007-0012256, filed on Feb. 6, 2007, which is hereby incorporated by reference as if fully set forth herein.

### BACKGROUND OF THE INVENTION

1. Field of the Invention

The present invention relates to a method and apparatus for outputting evaluation results obtained by automatically analyzing user-created contents, and recording media for storing a program implementing the same.

2. Discussion of the Related Art

Information and knowledge on the Internet may serve as the most important and competitive resource in a digital economy. Unlike the past conditions a particular group or user exclusively shared the information and knowledge on the Internet, there is a recently-developed paradigm in which the public serves as creators, participants and users on the Internet. The intellectual group of the Internet-users has been developed to an individual-focused platform to create new information, knowledge and culture. Many Internet-users need and use the high-quality contents, that is, various knowledge, wisdom, experience and information for living, created by the individual user.

The user-created contents (UCC) correspond to information spontaneously created by the Internet-users, for example, texts, pictures, photos and moving pictures. Nowadays, the Internet-users reach a high level of expert to create, deform and process the contents through the use of various means. In the past, the Internet-users passively accepted the information on the Internet. Now, the Internet-users are actively participating in creating the information beyond the passive attitude of the past time. Accordingly, the UCC is not merely means for satisfying the creator, but means for exerting influence on the public in the same level as the off-line broadcasting.

### SUMMARY OF THE INVENTION

Therefore, the present invention has been made in view of the above problems, and it is an object of the present invention to provide a method and apparatus for evaluating Internet contents, and recording media for storing program implementing the same, which can satisfy the demand of Internet users in recent days, by improving reliability on evaluating the value of Internet contents created by users or Internet community site including the corresponding contents through the use of an automatic robot, so as to induce the creation of high valued contents and build the foundation of the new commercial transaction through the Internet contents.

It is another object of the present invention to provide database especially built for real users having high valued contents by collecting and storing the information about both the user who requests the evaluation and the corresponding contents.

It is yet another object of the present invention to provide a method for evaluating the value of corresponding Internet contents by substituting various factors (bulletins, replies, trackbacks, the number of displaying the Internet contents on the web, the number of visitors, page view, and so on) into a predetermined algorithm, and recording media readable by a computer stored a program therein to execute the evaluation method, wherein the various factors are generated by steps of that the user freely uploads diary-type texts on the Internet contents, and openly communicates with unspecified Internet-users.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of evaluating Internet contents includes receiving location information of Internet contents; automatically extracting predetermined evaluation factors from the Internet contents corresponding to the received location information; evaluating the Internet contents by substituting the extracted evaluation factors into a predetermined algorithm; and outputting evaluation results. In addition, the method may include additionally receiving basic information about the Internet contents and/or applying a predetermined weight to the evaluation results so as to regularly reflect the change of reliability on the evaluation results at every predetermined period.

In another aspect of the present invention, an apparatus of evaluating Internet contents includes an input module receiving location information of Internet contents; a robot module automatically extracting predetermined evaluation factors from the Internet contents corresponding to the location information; an evaluation module evaluating a value of the Internet contents by substituting the extracted evaluation factors into a predetermined algorithm; and an output module outputting evaluation results.

In this case, the input module additionally receives basic information about the Internet contents. Also, the evaluation module applies a predetermined weight to the evaluation results so as to regularly reflect the change of reliability on the evaluation results at every predetermined period.

In another aspect of the present invention, recording media is provided, which is readable by a computer stored a program therein to execute the aforementioned evaluation method.

The present invention relates to the method and program of evaluating the results (tag, citation, reference, reply, tracback, etc.) based on behavioral manners between a blog operator and a blog visitor in user-created contents UCC (for example, post) being suitable for explaining a concept all things valued are created by the individual and spread wide in the public. The evaluation method and program of the present invention provide a preferable evaluation model for the UCC including the public's knowledge, experience and wisdom.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram briefly explaining a concept of an evaluation method of Internet contents according to the present invention;

FIG. 2 is a block diagram illustrating a method for evaluating Internet contents according to the present invention;

FIG. 3 is a diagram illustrating one detailed example of screen showing an analytical results report about a corresponding blog; and

FIG. 4 is a block diagram illustrating an evaluation method according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, a method and apparatus of evaluating Internet contents according to the present invention, and recording media of storing program implementing the same will be described with reference to the accompanying drawings.

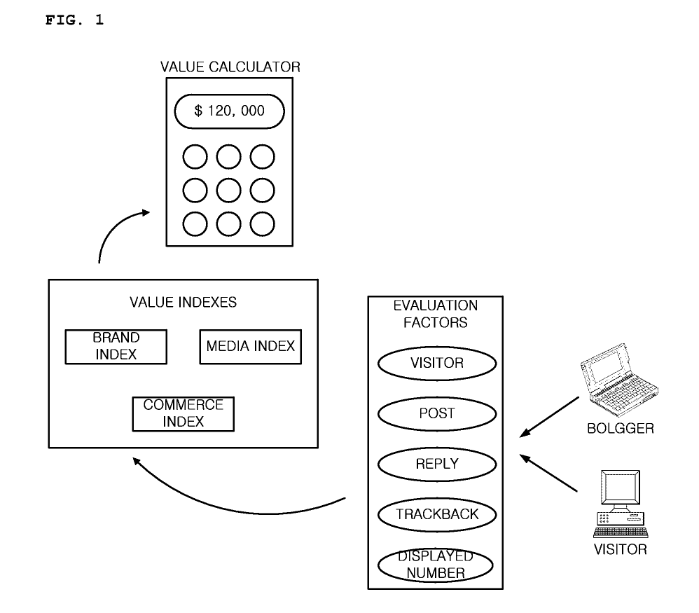

FIG. 1 is a diagram briefly explaining a concept of an evaluation method of Internet contents according to the present invention.

The term of Internet contents includes all media productions generated and published by users in web, for example, bulletin, digital video, digital audio, podcasting, mobile phone photography and moving picture, wikis and so on. The evaluation method of the present invention can be applied to the contents generated by the individual user, and further to the contents of Internet community to share the user-generated contents, for example, Internet homepage, simplified mini homepage, blog, bulletin board of Internet portal site, Internet club, Internet café and the like. The user-generated contents refer to various kinds of media contents produced by the unprofessional and general public and published in web. This may be referred to as user-created contents (UCC).

Hereinafter, a contents-evaluating process in one typical example of the aforementioned Internet contents, blog, according to the present invention will be explained as follows.

First, supposing that the following three are evaluated in a blog.

1) Blogger

It evaluates a user who operates and manages the blog. A blogger type is determined based on analyses of behavioral patterns of blogger and visitor through a frequency of producing UCCs or bulletins such as posts, a frequency of writing comments for a trackback, a frequency of writing replies to the comment written by another blogger, a frequency of writing replies to the reply, the number of tags, and a post category.

The blogger type may be largely classified into three types: one who creates the contents by oneself, another who blogs with the contents taken from other bloggers, the third who updates the contents of blog irregularly or rarely. In addition, there may be various types of blogger.

2) Blog

This is to evaluate the blog itself, to the exclusion of blog operator. For example, the evaluation of blog is made based on a fixed value with reference to the number of visitors, the number of posts, the number of comments, the number of trackbacks, the number of posts included in the blog, and the like. The corresponding blog may be evaluated comprehensively by one composite index considering all the aforementioned evaluation factors, or may be evaluated by each index indicating the particular evaluation factor, for example, a media index, a brand index, a commerce index, and the like. The detailed explanation for the evaluation of blog will be followed.

3) Post

This is to evaluate a post included in the blog, that is, to evaluate a particular user-created content (UCC). In detail, each of the posts included in the blog is evaluated based on the number of comments for the corresponding post, the number of citations or references for the corresponding post, whether or not the tag exists (the number of tags, if there are the tags), the number of written replies, the number of trackbacks, and a link structure relevant to whether there are attached files of text, image, audio, video and the like.

Once the evaluation for one of the blogger, blog and post; the evaluation result for the blogger, blog or post is valid for a preset period of time. According as the blogger, blog or post is changed in its content with the passage of time, the evaluation result of blogger, blog or post is valid not infinitely but limitedly. This is referred to as “validity period of evaluation result”. Preferably, the validity period of evaluation result is set between one week and two weeks since the blogger and blog are provided with a relatively long period to change the content thereof. Meanwhile, the validity period of evaluation result in the post is limited to the moment of evaluation, preferably, since the post is provided with a relatively short period to change the content thereof. However, these correspond to one embodiment. The validity period of evaluation result may be variable in consideration to the subject of blog, and the residence area of blogger.

Hereinafter, the detailed explanation for the aforementioned three indexes of brand index, media index and commerce index will be made as follows. These standards for evaluating the respective sections in the corresponding blog are referred to as value indexes. For evaluating the corresponding blog, it is unnecessary to use all the three indexes. According to the purpose of evaluating the corresponding blog, the three indexes may be used selectively.

Brand Index

The brand index shows how valuable the corresponding blog is in use as a product or service. If the corresponding blog obtains the great reliability in its content through the continuous supply of good-quality information including information relevant to a particular research field as well as information helpful for a virtual life, the corresponding blog may function as a high value added brand name to the visitors via web, who are prospective consumers, beyond a site for providing the simple information.

Preferably, the brand index is calculated through the analysis of reputation for the corresponding blog, that is, how widely the corresponding blog is known as the good one to the public. Thus, the brand index for the corresponding blog can be calculated based on whether or not the corresponding blog is registered in RSS (Really Simple Syndication/Rich Site Summary) and the post included in the corresponding blog is read often by other bloggers, whether or not the comment or reply of corresponding blog is actively posted by trackback, whether or not the corresponding blog is frequently displayed to the various search sites, and how many visitors or re-visitors are on average in the corresponding blog.

Media Index

The media index shows the influence of corresponding blog to the public, that is, how influential the corresponding blog is in web. That is, the media index is provided to estimate the accessibility to the public via web. This media index can utilize the evaluation factors of the aforementioned brand index. However, the application of the same evaluation factors doesn't mean that the possibility of spreading the corresponding blog in the public corresponds to the brand index. Generally, the brand index is prior to the media index. In this respect, the brand index for the particular evaluation factor is firstly calculated, and the result obtained by subtracting the brand index from the total index is determined to the media index, preferably.

Commerce Index

The commerce index shows the financial value of the corresponding blog. Simply, the commerce index is calculated by adding the media index and the brand index. In addition, the commerce index may be determined in consideration to the other factors such as costs for newly making the blog, and maintaining and managing the blog.

Hereinafter, one example of algorithm to determine the aforementioned brand index, media index and commerce index can be shown in numerical equations on the basis of the evaluation factors, for example, the number of posts, the number of trackbacks, the number of replies, the number of links, the number of tags, the average number of visitors for one day in the corresponding blog, and the activity of corresponding blog by the post/reply/trackback.

Most of the aforementioned factors for the evaluation of the corresponding blog are determined with a total value from the moment of creating the corresponding blog to the moment of evaluating the corresponding blog. However, the average number of visitors for one day and the activity of corresponding blog are determined with a total value for a preset period of time, for example, recent one month including the date of evaluating the corresponding blog.

On assumption of that the corresponding blog includes ‘k’ posts, some of the ‘k’ posts included in the corresponding blog can be trackbacked to the other blog. This can be expressed as the simple numerical equation. That is, the total number of trackbacked posts included in the corresponding blog corresponds to

$${\sum }_{i = 1}^{k} {\sum }_{j = D}^{n} {Y}_{ij}$$

(when j=0, Y_{iD}=0). In this case, Yᵢⱼ means that the ‘i’-th post has the ‘j’ trackbacks. For example, on assumption that the first post has trackbacked three times and the third post has trackbacked one time among the five posts included in the corresponding blog, the number of trackbacks of the corresponding blog corresponds to the four (3+0+1+0+0=4).

The reply can be written on some of the ‘k’ posts included in the corresponding blog. In this embodiment of the present invention, one post can include the ten replies at maximum. If writing the replies above 10, it is regarded as the same as the case of writing the replies of 10. Thus, the case of writing the replies above 10 is evaluated as the same as the case of writing the 10 replies. This can be expressed as the simple numerical equation. That is, the total number of replies in the corresponding blog corresponds to

$${\sum }_{i = 1}^{k} {\sum }_{j = 0}^{1 D} {Y}_{ij}$$

(when j=0, Y_{iD}=0) . In this case, Yᵢⱼ means that the ‘i’-th post has the ‘j’ replies.

Also, some of the ‘k’ posts included in the corresponding blog may have link information, in which the total number of links in the blog corresponds to

$${\sum }_{i = 1}^{k} {\sum }_{j = D}^{n} {Y}_{ij}$$

(when j=0, Y_{iD}=0) . At this time, Yᵢⱼ means that the ‘i’-th post has the ‘j’ links.

Also, a tag may be made on some of the ‘k’ posts included in the corresponding blog. In this embodiment of the present invention, one post can include the six tags at maximum. If providing the tags above 6, it is evaluated enough for one post, whereby it is regarded as the same as the case of providing 6 tags. This can be expressed as the simple numerical equation, that is, the total number of tags in the blog corresponds to

$${\sum }_{i = 1}^{k} {\sum }_{j = 0}^{6} {Y}_{ij}$$

(when j=0, Yᵢ₀=0). At this time, Yᵢⱼ means that the ‘i’-th post has the ‘j’ tags.

Also, the average number of visitors for the recent one month (30 days) including the date of evaluating the corresponding blog can be expressed as the simple numerical equation of

$${\sum }_{i = 1}^{30} \frac{{Y}_{i}}{30} .$$

The activity of corresponding blog can be evaluated with the number of posts, the number of trackbacks and the number of replies for the recent one month (30 days) including the date of evaluating the corresponding blog. This can be expressed as “the number of posts

$$+ \frac{1}{2}$$

the number of trackbacks

$$+ \frac{1}{3}$$

the number of replies” (one post can include the six replies at maximum). These can be shown in the following table 1.

TABLE 1

| Evaluation | Numerical | |
|---|---|---|
| factor | equation | Remark |
| The number of | K | |
| Posts (X₁) | | |
| The number oftrackbacks (X₂) | ${\sum }_{i = 1}^{k} {\sum }_{j = D}^{n} {Y}_{ij}$ | The period isnot limited,Y_{iD} = 0 when j = 0 |
| The number ofreplies (X₃) | ${\sum }_{i = 1}^{k} {\sum }_{j = 0}^{1 D} {Y}_{ij}$ | The period isnot limited,Y_{iD} = 0 when j = 0 |
| The number oflinks (X₄) | ${\sum }_{i = 1}^{k} {\sum }_{j = D}^{n} {Y}_{ij}$ | The period isnot limited,Y_{iD} = 0 when j = 0 |
| The number oftags (X₅) | ${\sum }_{i = 1}^{k} {\sum }_{j = 0}^{6} {Y}_{ij}$ | The period isnot limited,Y_{iD} = 0 when j = 0 |
| The averagenumber ofvisitors forone day (X₆) | ${\sum }_{i = 1}^{30} {Y}_{i} / 30$ | The recent onemonth (30 days) |
| The activity ofblog (X₇) | $\begin{matrix}the number of posts + \\ \frac{1}{2} the number of trackbacks + \\ \frac{1}{3} the number of replies\end{matrix}$ | The recent onemonth (30 days),one postincluding sixreplies. |

The evaluation results may be changed with the passage of time. The different weights may be applied by each period, so as to reflect the change of time on the evaluation of corresponding blog. For example, the periods can be classified into [period 1: the date of evaluating the corresponding blog˜(−90 day)], [period 2: (−91 day)˜(−180 day)], and [period 3: (−181 day)˜(−365 day)] and [period 4: after (−366 day)]. Then, the evaluation result of [period 1] is multiplied by the weight 1; the evaluation result of [period 2] is multiplied by the weight 0.8; the evaluation result of [period 3] is multiplied by the weight 0.5; and the evaluation result of [period 4] is multiplied by the weight 0.3. These are shown in the following table 2.

TABLE 2

| | The date of | | | |
|---|---|---|---|---|
| | evaluation~ | (−90)~ | (−180)~ | |
| | (−90) | (−180) | (−365) | (−365)~ |
| weight | 1 | 0.8 | 0.5 | 0.3 |

The process of calculating the brand index, the media index, and the commerce index through the use of the aforementioned evaluation factors is described as follows. In this case, Xᵢ expresses the ‘i’-th evaluation factor; Zᵢ expresses the evaluated value (evaluated cost) for the ‘i’-th evaluation factor; and Kᵢ expresses the brand index ratio for the ‘i’-th evaluation factor.

The brand index is calculated by multiplying the preset evaluation value and each evaluation factor, and multiplying the multiplied result by the proportion of corresponding evaluation factor as the brand. In consideration to all evaluation factors, the brand index can be simply expressed as

$${\sum }_{i = 1}^{?} {X}_{i} {Z}_{i} {K}_{i} .$$

This can be also expressed as follows.

$$\begin{matrix}\begin{matrix}\begin{matrix}The brand index \text{:} evaluation factor \times \\ evaluation value \times \end{matrix} \\ brand index ratio\end{matrix} = {X}_{1} {Z}_{1} {K}_{1} + {X}_{2} {Z}_{2} {K}_{2} + {X}_{3} {Z}_{3} {K}_{3} + \\ {X}_{4} {Z}_{4} {K}_{4} + {X}_{5} {Z}_{5} {K}_{5} + {X}_{6} {Z}_{6} {K}_{6} + \\ {X}_{7} {Z}_{7} {K}_{7} \\ = {\sum }_{i = 1}^{?} {X}_{i} {Z}_{i} {K}_{i}\end{matrix}$$

The media index is calculated by multiplying the preset evaluation value and each evaluation factor, and multiplying the multiplied result by the proportion of corresponding evaluation factor as the media. As explained above, the brand value is more prior than the media value that serves as the concept of spreading the corresponding blog in the public, that is, “the corresponding blog becomes popular”. Thus, the proportion of corresponding evaluation factor as the media can be expressed as the result obtained by subtracting the brand index from the total index, that is, ‘1−brand index ratio’. In consideration to all evaluation factors, the media index can be expressed as

$${\sum }_{i = 1}^{?} {X}_{i} {Z}_{i} ( 1 - {K}_{i} ) .$$

$$\begin{matrix}\begin{matrix}\begin{matrix}The media index : evaluation factor \times \\ evaluation value \times \end{matrix} \\ ( 1 - brand index ratio )\end{matrix} = {X}_{1} {Z}_{1} ( 1 - {K}_{1} ) + {X}_{2} {Z}_{2} ( 1 - {K}_{2} ) + \\ {X}_{3} {Z}_{3} ( 1 - {K}_{3} ) + {X}_{4} {Z}_{4} ( 1 - {K}_{4} ) + \\ {X}_{5} {Z}_{5} ( 1 - {K}_{5} ) + {X}_{6} {Z}_{6} ( 1 - {K}_{6} ) + \\ {X}_{7} {Z}_{7} ( 1 - {K}_{7} ) \\ = {\sum }_{i = 1}^{?} {X}_{i} {Z}_{i} ( 1 - {K}_{i} )\end{matrix}$$

The commerce index expresses the total value of the corresponding blog. Simply, the commerce index can be calculated by adding the brand index and the media index. The commerce index can be expressed as

$${\sum }_{i = 1}^{?} {X}_{i} {Z}_{i} ,$$

as follows.

The commerce index: brand index+media index

$$= {\sum }_{i = 1}^{?} {X}_{i} {Z}_{i} {K}_{i} + {\sum }_{i = 1}^{?} {X}_{i} {Z}_{i} ( 1 - {K}_{i} ) = {\sum }_{i = 1}^{?} {X}_{i} {Z}_{i}$$

One example for the ratio of the evaluation value to the brand index in each evaluation factor can be shown as the following table 3.

TABLE 3

| Evaluation factor | Evaluation value | | Brand index ratio | |
|---|---|---|---|---|
| (Xᵢ) | (Zᵢ) | | (Kᵢ) | |
| The number of posts | 3,500 | (Z₁) | .8 | (K₁) |
| (X₁) | | | | |
| The number of trackbacks | 2,500 | (Z₂) | .5 | (K₂) |
| (X₂) | | | | |
| The number of replies | 2,000 | (Z₃) | .8 | (K₃) |
| (X₃) | | | | |
| The number of links | 1,500 | (Z₄) | 1.0 | (K₄) |
| (X₄) | | | | |
| The number of tags | 500 | (Z₅) | .8 | (K₅) |
| (X₅) | | | | |
| The average number of | 1,000 | (Z₆) | .2 | (K₆) |
| visitors for one day | | | | |
| (X₆) | | | | |
| The activity of blog | 3,000 | (Z₇) | .4 | (K₇) |
| (X₇) | | | | |

The evaluation method applied to the aforementioned embodiment of the present invention can be expressed as the following equations. At this time, the evaluation factors X1˜X7 of the table 1 and table 3 correspond to A˜G of the following table 4, respectively.

TABLE 4

| | | | | Level | | |
|---|---|---|---|---|---|---|
| | | | | value | Brand | Media |
| Index | | description | Level | (Z) | index | index |
| Domainownership | ${\sum }_{i = 1}^{n} {X}_{i} Z$ | | | | | |
| The numberof posts(=A) | ${\sum }_{i = 1}^{n} {X}_{i} Z$ | | B⁺ | 3,500 | 0.8 | 0.2 |
| The numberoftrackbacks(=B) | ${\sum }_{i = 1}^{n} ( {\sum }_{j = 1}^{10} {X}_{i , j} )$ | | B⁻ | 2,500 | 0.5 | 0.5 |
| The numberof replies(=C) | ${\sum }_{i = 1}^{n} {X}_{i} Z$ | One postincludes 10replies atmaximum | C⁺ | 2,000 | 0.8 | 0.2 |
| The averagenumber ofvisitorsfor oneday (=D) | ${\sum }_{i = 1}^{n} {X}_{i} Z ,$ (i = exceptthescrappedpost amongthe totalposts) | | C⁻ | 1,000 | 0.2 | 0.8 |
| The numberof links(=E) | ${\sum }_{i = 1}^{n} ( {\sum }_{j = 1}^{6} {X}_{i , j} ) Z$ | The numberof links oftheremainingpost exceptthescrappedpost | C0 | 1,500 | 1 | — |
| The numberof tags(=F) | AZ₁ + (B + C)Z₂ | One postincludes 6tags atmaximum | D⁺ | 500 | 0.8 | 0.2 |
| Theactivityof blog(=G)(A, B, C) | ${\sum }_{i = A}^{F} {X}_{i}$ | The numberof posts,trackbacksand repliesfor therecent onemonth | B0 | 3,0002,000 | 0.4 | 0.6 |

For reference, the evaluation value (or evaluated cost) of the table 4 is classified into 12 levels, for example, A+, A0, A−˜D+, D0, D−, on the basis of the preset standard.

In the aforementioned embodiment of the present invention, the brand index, media index and commerce index are calculated in consideration to the seven evaluation factors. However, the brand index, media index and commerce index can be expressed as the following typical models without limiting to the number of evaluation factors.
Brand Index:

$${\sum }_{i = 1}^{n} {X}_{i} {Z}_{i} {K}_{i} ,$$

(‘n’ is the number of evaluation factors)
Media Index:

$${\sum }_{i = 1}^{n} {X}_{i} {Z}_{i} ( 1 - {K}_{i} ) ,$$

(‘n’ is the number of evaluation factors)
Commerce Index:

$${\sum }_{i = 1}^{n} {X}_{i} {Z}_{i} ,$$

(‘n’ is the number of evaluation factors)

The results obtained by the aforementioned algorithm can be expressed as the average, the financial amount or the evaluation writing. That is, when the total of evaluation's score is 100, the average is obtained by calculating the evaluation score for the corresponding blog. The financial amount can be obtained by calculating the evaluated factors of the corresponding blog in terms of money, so that the corresponding blog can be expressed as the evaluated cost (evaluated value) on the basis of the evaluated financial amount. The evaluation writing can be expressed as the texts in relation with the inclination of operator of the corresponding blog, the trend in blog, and the tendency of users (visitors). Expressing the evaluated value for the corresponding blog is not limited to the aforementioned average, the financial amount or the evaluation writing. The evaluation result for the corresponding blog can be expressed in various methods.

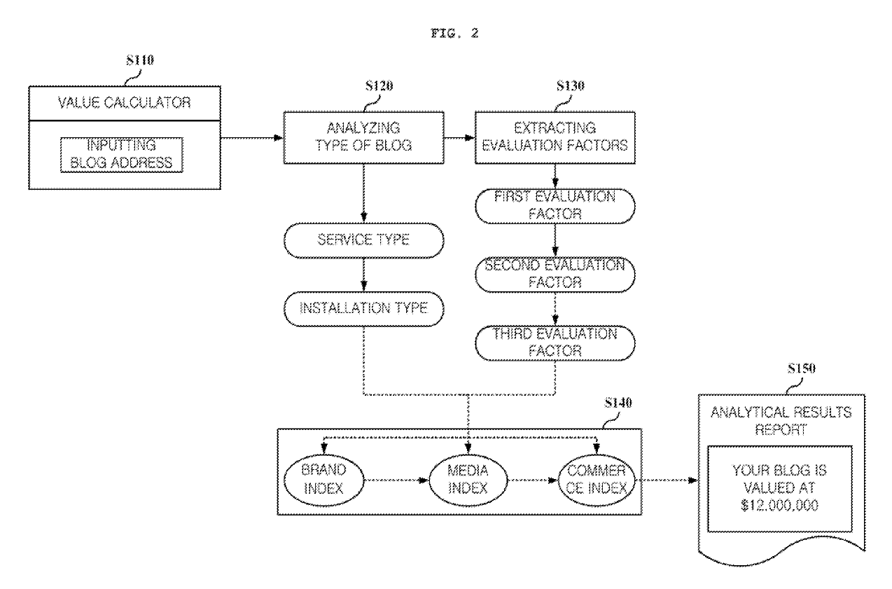

Next, a process of performing the evaluation for the corresponding blog through the use of the aforementioned evaluation algorithm will be described in detail as follows. FIG. 2 is a block diagram illustrating steps of an evaluation method according to the present invention.

The user accesses the web site which provides the service of evaluating the blog, or executes a program to evaluate the blog. Then, the user inputs location information or address information (for example, URL) of the corresponding blog to be evaluated (S110). That is, the program to evaluate the corresponding blog may be realized in an independent application, or in a website-based application using Java script, Active X, or .Net. Hereinafter, both the independent application and the website-based application are referred to as the evaluation program.

The evaluation program analyzes the type of corresponding blog (S120) by storing the location information inputted by the user in a first database, and reading files relevant to the corresponding blog from the address corresponding to the location information; and extracts predetermined factors from the corresponding blog (S130).

The type of blog may be largely classified into a service type to use the blog service provided from the portal site, and an installation type to directly install the blog program in one's own homepage. In addition, the blog may include PC-installation type or solely-developed type. In case of the PC-installation type, the evaluation process of the present invention can be realized with easiness owing to the relatively easy access to the files relevant to the corresponding blog. To extract the evaluation factors from the corresponding blog, a robot program may be utilized, which will be explained as follows.

Meanwhile, the evaluation factors to be extracted from the corresponding blog may be classified into three on the basis of an object to be evaluated.

First, the first evaluation factor is to analyze the inclination of operator, that is, blogger who operates the corresponding blog. The first evaluation factor includes at least one of the frequency of writing the post, the frequency of writing the comment, and the frequency of writing the reply to the comment written by the other blogger for a preset period of time. This first evaluation factor shows how actively the operator manages the blog; the attitude of operator toward the acquaintances and visitors via web; and the participation in the other blog. This has been already mentioned in the explanation regarding the standard for evaluation of the blogger.

The second evaluation factor is to evaluate the blog itself. The second evaluation factor includes at least one of the total number of posts included in the corresponding blog, the number of posts per each month, the number of visitors via web, the number of re-visitors via web, the number of replies, the number of scraps, and the number of acquaintances via web. This second evaluation factor shows the brand value of the blog service provided, the media value by the spreading of reputation for the blog in the public, and the commercial value created by the corresponding blog. This has been already mentioned in the explanation regarding the standard for evaluation of the blog.

The third evaluation factor is to evaluate the particular post included in the corresponding blog. This third evaluation factor includes at least one of the number of replies, the number of scraps, and the number of feedbacks to the particular post. The third evaluation factor shows the value of particular post, that is, how valuable the particular post is in use of writing or information source. This has been already mentioned in the explanation regarding the standard for evaluation of the post.

The evaluation factors to be extracted from the blog are classified into common factors and specified factors, based on whether the factors are utilized for the virtual evaluation or not. That is, the common factors are directly utilized for the evaluation of blgger, blog and post. Even though the specified factors are not directly utilized for the evaluation thereof, the specified factors are separately managed and secondarily utilized for the next evaluation. The aforementioned first to third evaluation factors correspond to the common factors. The statistical data for each blog corresponds to the specified factor, which is separately managed in a third database, preferably.

The evaluation program performs the evaluation for the blogger, blog and post by substituting the first to third evaluation factors into a predetermined algorithm. Especially, when evaluating the blog, the brand index, media index and commerce index for the corresponding blog are necessarily calculated (S140). The predetermined algorithm for evaluating the blog has been explained above. The evaluation method for the particular post included in the blog is almost identical to the evaluation method for the blog.

However, in case of evaluation for the blogger, the blogger is evaluated according to a blogger-type report written with expressions corresponding to the numerical evaluation results under the aforementioned evaluation method of the blog. For this, the evaluation program may use a second database which stores a plurality of announcements prepared based on the type of blogger and the evaluation level (or numerical value) in the corresponding type of blogger. The announcements may be provided in type of general texts or voice data.

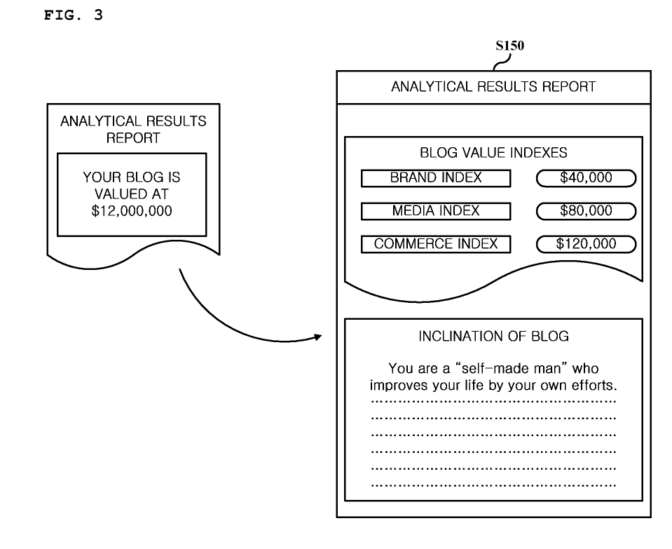

The evaluation results can be outputted in type of a report (S150). This is referred to as an analytical results report. The detailed example of screen showing the analytical results report for the predetermined blog is shown in FIG. 3.

As shown in FIG. 3, the analytical results report may include two sectors, largely. The first sector relates with the evaluation results for the corresponding blog. Thus, the first sector converts the brand index, media index and commerce index into the amount of money; and outputs the converted result. The second sector relates with the evaluation results for the blogger who operates the corresponding blog. The detailed explanation and/or consulting results for the type of corresponding blogger and the corresponding type of blogger can be formed and outputted in type of text.

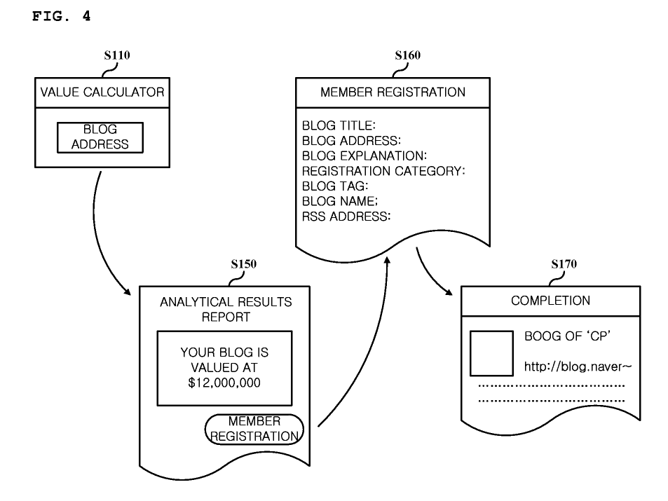

The analytical results report corresponds to primary results obtained by mechanically analyzing the evaluation algorithm. According as the basic information for the corresponding blog is additionally provided to the analytical results report from the user, it enables the high reliability of evaluation results report. For reference, FIG. 4 is a block diagram illustrating an evaluation method according to the present invention.

That is, after the analytical results report is outputted (S150), the user selects “member registration” from the report, and inputs the basic information for the blog and blogger, so as to register as the member (S160). The evaluation program generates the final evaluation results report by adding the basic information to the analytical results report; and outputs the finally-obtained report to the user (S170). In this case, the basic information inputted by the user includes at least one of the title of corresponding blog, the address of corresponding blog, the explanation for corresponding blog, the registration category (corresponding to the directory service of the search portal site), the blog tag, the name of corresponding blog, and the RSS address.

The step for the registration as the member (S160) may be carried out before the evaluation and result report steps (S120˜S150). In this case, the user has to complete the step for the registration of member (S160) so as to proceed to the next steps (S120˜S150), so that it enables the obligatory input of basic information about the corresponding blog and blogger.

Through the aforementioned step for inputting the basic information about the corresponding blog and blogger, the evaluation process can be performed with the correct and detailed information about the corresponding blog and blogger. The additionally supplied information as well as the information accumulated for the evaluation process can be utilized when ranking the blog or commercially using the blog.

The evaluation results are stored in the first database, and the stored evaluation results are used as the information to rank the blogs evaluated based on the evaluation program of the present invention.

The aforementioned evaluation program can be realized in type of hardware. For convenience, when it is referred to as an evaluation apparatus, the evaluation apparatus is provided with an input module (not shown in the drawings) receiving the location information of Internet contents; a robot module (not shown in the drawings) automatically extracting predetermined evaluation factors from the Internet contents of the location information inputted; an evaluation module (not shown in the drawings) evaluating a value of the Internet contents by substituting the extracted evaluation factors into a predetermined algorithm; and an output module (not shown in the drawings) outputting the evaluation information about the Internet contents. At this time, the input module may receive the basic information about the Internet contents, additionally.

Especially, the robot module includes a first robot (BlogBotI) to extract the first evaluation factor from the corresponding blog. In addition, the robot module may include a second robot (BlogBotT) to extract the second evaluation factor from the corresponding blog, and a third robot (BlogBotP) to extract the third evaluation factor from the corresponding blog. The robot module is widely used for the web search in the related art search portal site, of which the detailed explanation will be omitted.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

Especially, the aforementioned embodiment of the present invention relates to the blog among the various Internet contents. However, it is apparent to those skilled in the art that the present invention can be applied to the various Internet contents as well as the blog without difficulties. Also, it is assumed that the aforementioned embodiment of the present invention is realized by the website-based application for the evaluation of corresponding blog, but it is not limited to this. That is, the present invention can be realized by the independent application which is installed through the download from a preset website.

The method for evaluating the corresponding Internet contents according to the present invention can improve the fairness and reliability on its evaluation result for the Internet contents through the use of automatic method applied to the evaluation of the Internet contents created by the user or the Internet community site including the corresponding contents. Furthermore, the evaluation method of the present invention can induce the creation of high-quality contents, and can contribute the spread of concept that the content corresponds to the asset, thereby building the foundation for development of the Internet business in new fields.

Also, a new trend in the evaluation of Internet contents is that the users owning the high-quality contents make a request for the evaluation of their own contents. Accordingly, the database for the high valued contents and the real users owning the high-quality contents can be obtained through the evaluation method of the present invention, resulting in the high fairness and reliability on ranking the contents.

1. A method for evaluating Internet contents comprising:
receiving location information of Internet contents;
automatically extracting predetermined evaluation factors from the Internet contents corresponding to the received location information;
evaluating the Internet contents by substituting the extracted evaluation factors into a predetermined algorithm; and
outputting evaluation results.

2. The method according to claim 1, wherein the evaluation factors include the first evaluation factor to evaluate an inclination of a creator of the Internet contents.

3. The method according to claim 2, wherein the evaluation factors include the second evaluation factor to totally evaluate the entire Internet contents.

4. The method according to claim 3, wherein the evaluation factors include the third evaluation factor to evaluate some of the Internet contents.

5. The method according to claim 2, wherein the Internet contents correspond to a blog, and the first evaluation factor includes at least one of a frequency of writing posts, a frequency of writing comments about the other's post, and a frequency of writing replies to the comment written by the others for a preset period of time.

6. The method according to claim 3, wherein the Internet contents correspond to a blog, and the second evaluation factor includes at least one of the total number of posts included in the blog, the number of written posts per month, the number of visitors, the number of re-visitors, the number of written replies, the number of scraps, and the number of acquaintances via web.

7. The method according to claim 4, wherein the Internet contents correspond to a blog, and the third evaluation factor includes at least one of the number of written replies, the number of scraps, and the number of feedbacks to the predetermined post.

8. The method according to claim 1, further comprising additionally receiving basic information about the Internet contents.

9. The method according to claim 8, wherein the Internet contents correspond to a blog, and the basic information includes at least one of a title of blog, an explanation for blog, a category of blog, a blog tag, a RSS (Really Simple Syndication) address, and user's information.

10. The method according to claim 1, wherein the evaluation of Internet contents is performed with at least one of a brand index to evaluate the reliability of Internet contents and the accessibility to the public, a media index to evaluate the spreading of reputation for Internet contents in the public, and a commerce index to evaluate the commercial value of Internet contents.

11. The method according to claim 10, wherein the brand index is calculated by adding respective results obtained by multiplying an evaluated value for each evaluation factor extracted, a valuation amount for each evaluation factor, and a brand index ratio for each evaluation factor.

12. The method according to claim 11, wherein the media index is calculated by adding respective results obtained by multiplying an evaluated value for each evaluation factor extracted, a valuation amount for each evaluation factor, and a media index ratio for each evaluation factor.

13. The method according to claim 12, wherein the commerce index is calculated by adding the brand index and the media index.

14. The method according to claim 1, further comprising applying a predetermined weight to the evaluation results so as to regularly reflect the change of reliability on the evaluation results at every predetermined period.

15. An apparatus for evaluating Internet contents comprising:
an input module receiving location information of Internet contents;
a robot module automatically extracting predetermined evaluation factors from the Internet contents corresponding to the location information;
an evaluation module evaluating a value of the Internet contents by substituting the extracted evaluation factors into a predetermined algorithm; and
an output module outputting evaluation results.

16. The apparatus according to claim 15, wherein the evaluation factors include the first evaluation factor to evaluate an inclination of a creator of the Internet contents.

17. The apparatus according to claim 16, wherein the evaluation factors include the second evaluation factor to totally evaluate the entire Internet contents.

18. The apparatus according to claim 17, wherein the evaluation factors include the third evaluation factor to evaluate some of the Internet contents.

19. The apparatus according to claim 16, wherein the Internet contents correspond to a blog, and the first evaluation factor includes at least one of a frequency of writing posts, a frequency of writing comments about the other's post, and a frequency of writing replies to the comment written by the others for a preset period of time.

20. The apparatus according to claim 17, wherein the Internet contents correspond to a blog, and the second evaluation factor includes at least one of the total number of written posts included in the blog, the number of written posts per month, the number of visitors, the number of re-visitors, the number of written replies, the number of scraps, and the number of acquaintances via web.

21. The apparatus according to claim 18, wherein the Internet contents correspond to a blog, and the third evaluation factor includes at least one of the number of written replies to the predetermined post, the number of scraps, and the number of feedbacks.

22-23. (canceled)

24. The apparatus according to claim 15, wherein the evaluation of Internet contents is performed with at least one of a brand index to evaluate the reliability of Internet contents and the accessibility to the public, a media index to evaluate the spreading of reputation for the Internet contents in the public, and a commerce index to evaluate the commercial value of Internet contents.

25. The apparatus according to claim 24, wherein the brand index is calculated by adding respective results obtained by multiplying an evaluated value for each evaluation factor, a valuation amount for each evaluation factor, and a brand index ratio for each evaluation factor.

26. The apparatus according to claim 25, wherein the media index is calculated by adding respective results obtained by multiplying an evaluated value for each evaluation factor, a valuation amount for each evaluation factor, and a media index ratio for each evaluation factor.

27. The apparatus according to claim 26, wherein the commerce index is calculated by adding the brand index and the media index.

28-29. (canceled)
